(19) United States
(12) Patent Application Publication
(10) Pub. No.: US 2026/0026490 A1
(43) Pub. Date: Jan. 29, 2026

(54) CARRYING OUT AND DOCUMENTING THE APPLICATION OF CROP PROTECTION PRODUCTS

(71) Applicants: BAYER AKTIENGESELLSCHAFT, Leverkusen (DE); AI.Land GmbH, Kempen (DE)

(72) Inventors: Matthias TEMPEL, Köln (DE); Alexander ROTH, Bergisch Gladbach (DE); Giuseppe LA TONA, Leverkusen (DE); Josef FRANKO, Kempen (DE)

(21) Appl. No.: 18/846,574

(22) PCT Filed: Mar. 10, 2023
(86) PCT No.: PCT/EP2023/056236

§ 371 Date: Sep. 12, 2024

(30) Foreign Application Priority Data
Mar. 16, 2022 (EP) 22162596.5

(51) Int. Cl. A01M 7/00; A01N 25/02; G06T 7/593; G06V 20/10

(52) U.S. Cl. CPC A01M 7/0089; A01N 25/02; G06T 7/593; G06V 20/188; G06T 2207/10012; G06T 2207/30188; G06V 2201/07

(57) ABSTRACT

The present invention relates to the technical area of the application of plant protection agent. The subjects of the present invention are a device and a method for the automated and precise application of one or more plant protection agents on a target object and for the documentation of the application.

### TECHNICAL AREA

The present invention relates to the technical area of the application of plant protection agent. The subjects of the present invention are a device and a method for the automated and precise application of one or more plant protection agents on a target object and for the documentation of the application.

### INTRODUCTION

Plant protection agents are used worldwide to protect plants or plant products from harmful organisms or prevent the effect thereof, to destroy unwanted plants or parts of plants, to inhibit unwanted growth of plants or prevent such growth, and/or to influence the life processes of plants in a way different from nutrients (e.g. growth regulators).

Autonomous systems are increasingly being used to recognize the cultivated plants and/or undesired accompanying plants automatically and to apply plant protection agents deliberately.

WO2017/178666A1, for example, discloses a set of autonomous devices which produce image recordings in a field for cultivated plants with the aid of a camera and feed the produced image recordings to an artificial neural network which was trained to distinguish wild plants from cultivated plants. The information about the respective plants present is used to apply plant protection agents deliberately.

WO2021/144785A1 discloses a system for biological real-time detection and treatment of a predefined condition of plants, comprising a control system, which recognizes predefined phenotypical features of plants on the basis of image recordings, and an execution unit configured to treat the predefined condition of the plants. The identification of plants and/or plant conditions is accompanied by a deliberate treatment of individual plants.

US2021/090274 describes an agricultural device having image sensors. While the device moves through a field, image recordings are taken and analyzed. The distance between the sensor and the object is ascertained, which is represented by a pixel in each case, as well as the useful plants, so that the treatment of the plants is then triggered.

CN107128484 describes how an autonomously flown flying object sprays an insecticide using inkjet technology at low height, which is monitored by cameras.

The systems which are currently on the market, however, do not provide any assurance that plant protection agents reach only where they are supposed to produce their effect, and avoid surrounding areas, therefore using the smallest amount which nonetheless achieves the desired effect.

Efforts are taken in organic agriculture to dispense with plant protection agents as much as possible. Avoiding diseases and pests is in the foreground. All cultivation measures such as crop rotation, fertilization, soil cultivation, or selection of species and variety are directed to limiting the propagation of harmful organisms.

If diseases or pests occur in spite of these precautionary measures, only a limited selection of plant protection agents can be used in organic agriculture. The use of plant protection agents is regulated in the EU legislation on organic agriculture: “in the case of an established threat to a crop, plant protection products may only be used if they have been authorised for use in organic production under Article 16” (Article 12 of Regulation 834/2007).

With Regulation 834/2007, the EU pursues the goal of minimizing the introduction of plant protection agents into the environment in order to avoid undesired following effects. The regulation is based on the conviction that application of plant protection agents under real conditions in the field necessarily results in contamination of the environment by plant protection agents.

Proceeding from the described prior art, the object presents itself of designing the use of plant protection agents so that the plant protection agent is demonstrably only applied in the smallest possible quantity where it is intended.

### SUMMARY OF THE PRESENT INVENTION

The present invention provides means, using which, on the one hand, plant protection agents can be applied deliberately and in the smallest possible quantity in which the plant protection agent can still produce its effect to a target object and, on the other hand, evidence is provided that the use of plant protection agents on the target object is limited.

A first subject matter of the present invention is a method comprising the following steps:
producing a first image recording of a target object,
identifying the target object on the basis of the first image recording,
determining the required application amount based on properties of the target object,
ascertaining a target region on the basis of the first image recording and/or on the basis of a second image recording,
applying an amount of plant protection agent to the target region with the aid of a dosing unit,
producing a third image recording, wherein the third image recording shows the plant protection agent applied to the target region,
generating a data set comprising
   the first and/or the second image recording,
   an item of information about the ascertained target object, and
   the third image recording,
outputting and/or storing the data set and/or transmitting the data set to a computer system.

A further subject matter of the present invention is a device comprising the following
a control and calculation unit,
at least one image recording unit,
a dosing unit, and
a data memory and/or a transmitting unit,
wherein the control and calculation unit is configured
to receive a first image recording from the at least one image recording unit,
to identify a target object in the first image recording,
optionally, to receive a second image recording from the at least one image recording unit,
to ascertain a target region on the basis of the first and/or second image recording,
to cause the dosing unit to apply an amount of a plant protection agent to the target region,
to cause the at least one image recording unit to generate a third image recording, wherein the third image recording shows the plant protection agent applied to the target region,
to generate a data set, wherein the data set comprises
   the first and/or the second image recording,
   an item of information about the ascertained target object, and
   the second image recording, and
to store the data set in the data memory and/or to cause the transmitting unit to transmit the data set to a computer system.

### DETAILED DESCRIPTION OF THE INVENTION

The invention is explained in more detail below without distinguishing between the subjects of the invention (method, device). The following explanations are rather to apply analogously to all subjects of the invention, independently of the context (method, device) in which they are given.

Where steps are stated in an order in the present description or in the claims, this does not necessarily mean that the invention is limited to the order stated. Instead, it is conceivable that the steps are also executed in a different order or else in parallel with one another, the exception being when one step builds on another step, thereby making it imperative that the step building on the previous step be executed next (which will however become clear in the individual case). The orders stated are thus preferred embodiments of the invention.

The present invention provides means for the deliberate treatment of a target object using a plant protection agent.

The term “plant protection agent” is understood as an agent used to protect plants or plant products from harmful organisms or prevent the effect thereof, to destroy unwanted plants or parts of plants, to inhibit unwanted growth of plants or prevent such growth, and/or to influence the life processes of plants in a way different from nutrients (e.g. growth regulators). Examples of plant protection agents are herbicides, fungicides, and insecticides. The plant protection agents mentioned as examples are also referred to as pesticides.

A plant protection agent within the meaning of the present invention is preferably a plant protection agent which can be brought into a liquid form. It is preferably present as a liquid in a temperature range from 4° C. to 35° C. under a pressure of 1013 mbar (air pressure at sea level). However, it is also conceivable that it is present in a different physical state and is only converted into a liquid form before the application (for example by heating in the case of a solid plant protection agent or by condensing a gaseous plant protection agent).

“Liquid” in this respect means that the plant protection agent can be brought into the form of a droplet by an external force. Therefore, the term liquid is also to include pasty media.

It is conceivable that multiple (different) plant protection agents are applied simultaneously or successively. In the present description, reference is predominantly made to a plant protection agent for reasons of better comprehensibility. However, this is not to be understood as a restriction to a single plant protection agent, but rather the term “a plant protection agent” is also to comprise multiple plant protection agents as well as a combination of plant protection agent with other substances and/or substance mixtures such as plant nutrients.

The target object which is to be treated using a plant protection agent can be a harmful organism.

A “harmful organism” is understood to mean an organism that can appear in the course of growing cultivated plants and damage the cultivated plants, adversely affect the harvest of the cultivated plant, or compete for natural resources with the cultivated plant. Examples of such harmful organisms are weeds, weed grasses, animal pests, for example beetles, caterpillars, and worms, fungi, and pathogens (e.g. bacteria and viruses). Even though viruses are not organisms from a biological point of view, they are nevertheless covered by the term “harmful organism” in the present case.

In a preferred embodiment, the target object is a weed plant. The term “weed” is understood to mean spontaneously accompanying vegetation in crops of cultivated plants, grassland, or gardens that are not being specifically grown there and develop, for example, from the seed potential of the soil or are blown in. The term is not limited to broadleaved plants in the actual sense, but also includes grasses, ferns, mosses, or woody plants. In the field of plant protection, the term “weed grass” is frequently also utilized in order to illustrate a delimitation from broadleaved plants. In the present text, the term weed is used as a generic term which is to include the term weed grass. Weeds within the meaning of the present invention are accordingly plants which appear as an accompaniment when a desired cultivated plant is cultivated. Since they compete for resources with the cultivated plant, they are undesired and are therefore to be combated.

In a further preferred embodiment, the target object is an animal harmful organism, such as an arthropod. About two thirds of the animal species currently known are arthropods (phylum of Arthropoda), 85% of which are represented by insects. A considerable proportion of arthropods is phytophagous: these animals feed on plants and can lead to impairment of growth, cause suction and biting damage, and transmit viral diseases. This causes, for example, considerable losses of yield and quality in the growing of cultivated plants. In one preferred embodiment, the animal pest is an insect (in the various stages from larva (caterpillar, pseudo-caterpillar) up to the adult stage) or an arachnid. The pest is more preferably an agricultural pest, for example codling moth, aphid, thrips, summer fruit tortrix, Colorado potato beetle, cherry fruit fly, cockchafer, European corn borer, plum fruit moth, rhododendron leafhopper, turnip moth, scale insect, gypsy moth, spider mite, European grapevine moth, walnut husk fly, glasshouse whitefly, oilseed rape stem weevil, cabbage stem weevil, rape pollen beetle, cabbage shoot weevil, brassica pod midge or cabbage stem flea beetle, or a forestry pest, for example aphid, steelblue jewel beetle, bark beetle, oak splendour beetle, oak processionary moth, green oak tortrix, spruce webworm, common furniture beetle, great brown bark eater, common pine sawfly, pine beauty, pine looper, lesser spruce sawfly, black arches, horse chestnut leaf miner, gypsy moth, or brown powderpost beetle.

In a further preferred embodiment, the target object is a cultivated plant infected by a fungus, a bacterium, or a virus. The term “cultivated plant” is understood to mean a plant which is specifically grown as a useful plant or ornamental plant by human intervention.

The treatment of a target object according to the invention can take place in four steps:
1. Identifying the target object and determining the dose
2. Ascertaining a target region
3. Applying a plant protection agent to the target region
4. Documenting the application

These steps take place in an automatic/automated manner, i.e., without human action.

These steps, which can in turn comprise multiple substeps, will be described in more detail hereinafter.

In a further preferred embodiment, a method is described, wherein in addition in step (c) the target region is ascertained on the basis of the first and second image recording, which are each produced from different directions, and wherein in step (f), the data set additionally comprises the second image recording and an item of depth information with respect to a distance of the dosing unit from the target region, which was obtained from the two image recordings.

In a further preferred embodiment, a method is described, wherein in addition in step (d), the plant protection agent is applied in the form of one or more individual droplets.

In a further preferred embodiment, a method is described, wherein in addition in step (e), the third image recording shows one or more individual droplets which have been applied to the target region in step (d).

In a further preferred embodiment, a method is described, wherein in addition the data set generated in step (f) additionally comprises the total amount of the plant protection agent applied in the target region.

In a further preferred embodiment, a method is described, wherein it is additionally ascertained on the basis of the data set generated in step (f) and by means of the third image recording contained therein whether and which amount of plant protection agent has arrived in the target region.

In a further preferred embodiment, a method is described, wherein in addition in step (d), the dosing unit has been installed on a windscreen, which ensures that one or more individual droplets of the plant protection agent do not drift off from the desired target track on their flight path from the dosing unit in the direction of the target region.

In a further preferred embodiment, a device is described comprising a control and computation unit, at least one image recording unit, a dosing unit, and a data memory and/or a transmitting unit, wherein the control and computation unit is configured to receive a first image recording from the at least one image recording unit, to identify a target object in the first image recording, optionally to receive a second image recording from the at least one image recording unit, to ascertain a target region on the basis of the first and/or second image recording, to cause the dosing unit to apply an amount of a plant protection agent to the target region, to cause the at least one first image recording unit to produce a third image recording, wherein the third image recording shows the plant protection agent applied to the target region, to generate a data set, wherein the data set comprises the first and/or the second image recording, an item of information about the ascertained target object, and the second image recording, and to store the data set in the data memory, and/or to cause the transmitting unit to transmit the data set to a computer system.

In a further preferred embodiment, a device is described, wherein the control and computation unit is configured to receive a second image recording from a second image recording unit, wherein the second image recording unit is positioned spatially different relative to the first image recording unit, to ascertain a target region on the basis of the first and second image recording, to cause the dosing unit to apply an amount of a plant protection agent to the target region, to cause the at least one first image recording unit to produce a third image recording, wherein the third image recording shows the plant protection agent applied to the target region, to generate a data set, wherein the data set comprises the first image recording, an item of information about the ascertained target object, and the second image recording.

In a further preferred embodiment, a device is described, wherein the dosing unit contains a storage container, a nozzle, a precision valve, and a micro-reservoir which is capable of applying droplets having a volume of 1 to 100 nL.

In a further preferred embodiment, a device is described, wherein the droplet has a volume of 1 to 50 nL.

In a further preferred embodiment, a device is described, wherein the first image recording unit and the second image recording unit are designed in the form of a stereo camera.

In a further preferred embodiment, a device is described, wherein the dosing unit is installed on a windscreen, which ensures that individual droplets of the plant protection agent do not drift off from the desired target track on their flight path from the dosing unit in the direction of the target region.

### Identifying the Target Object

Before a target object can be treated using a plant protection agent, the target object initially has to be recognized (identified).

The identification of the target object is carried out according to the invention on the basis of an image recording which shows the target object. It is conceivable that the identification is carried out on the basis of multiple image recordings (for example taken at time intervals and/or from different directions (viewing angles)). The one image recording or the multiple image recordings which is/are used for the identification of the target object is/are also referred to in this description as the first image recording/the first image recordings.

The term “image recording” is preferably understood to mean a two-dimensional image of an object or of a part thereof. The image recording is usually a digital image recording. The term “digital” means that the image recording can be processed by a machine, generally a computer system. “Processing” is understood to mean the known methods for electronic data processing (EDP). Digital image recordings can be processed, edited and reproduced and also converted into standardised data formats, such as JPEG (graphics format of the Joint Photographic Experts Group), PNG (Portable Network Graphics) or SVG (Scalable Vector Graphics), for example, by means of computer systems and software. Digital image recordings can be visualized by means of suitable display devices, such as computer monitors, projectors and/or printers, for example.

One or more first image recordings of the target object can be produced using one or more image recording units. Such an image recording unit can be a camera, for example.

An camera usually comprises an image sensor and optical elements. The image sensor is a device for recording two-dimensional images from light by electrical means. This usually involves a semiconductor-based image sensor, for example a CCD (CCD=charge-coupled device) or CMOS sensor (CMOS=complementary metal oxide semiconductor). The optical elements (lenses, stops and the like) serve for maximum sharpness of imaging of the object of which a digital image recording is to be generated on the image sensor.

Other devices and systems which can produce an image of an object, such as an arrangement of hyperspectral sensors, a thermal imaging camera (infrared camera), a laser scanner, a LIDAR system (LIDAR=light detection and ranging or light imaging, detection and ranging), an ultrasound source in combination with an ultrasound sensor, and/or combinations of multiple units are also to fall under the term “image recording unit”.

If the production of an image recording is based on the detection of the spatial distribution of electromagnetic beams, the electromagnetic beams can be part of the sunlight and/or can be generated by one or more artificial sources for electromagnetic radiation, such as LED (LED=light-emitting diode) and/or halogen radiators.

A trained machine learning model is preferably used for the identification of a target object on the basis of one or more first image recordings which show at least a part of the target object.

A “machine learning model” can be understood as a computer-implemented data processing architecture. The model can receive input data and supply output data on the basis of these input data and model parameters. The model can learn a relationship between the input data and the output data by means of training. During training, the model parameters can be adapted to supply a desired output for a specific input.

During the training of such a model, the model is presented with training data from which it can learn. The trained machine learning model is the result of the training process. Besides input data, the training data include the correct output data (target data) that are to be generated by the model on the basis of the input data. During training, patterns that map the input data onto the target data are recognized.

In the training process, the input data of the training data are input into the model, and the model generates output data. The output data are compared with the target data. Model parameters are altered so as to reduce the differences between the output data and the target data to a (defined) minimum.

During training, a loss function can be used to assess the prediction quality of the model. The loss function can be chosen such that it rewards a desired relationship between output data and target data and/or punishes an undesired relationship between output data and target data. Such a relationship can be e.g. a similarity, a dissimilarity or some other relationship.

Such a loss function can be used to calculate a loss value for a given pair of output data and target data. The goal of the training process can consist of altering (adapting) the parameters of the machine learning model so that the loss value for all pairs of the training data set is reduced to a (defined) minimum.

A loss function can quantify e.g. the deviation between the output data of the model for specific input data and the target data. For example, if the output data and the target data are numbers, the loss function can be the absolute difference between these numbers. In this case, a high absolute value of the loss function can mean that one or more model parameters must be changed to a great extent.

In the case of output data in the form of vectors, for example, difference metrics between vectors such as the mean squared error, a cosine distance, a norm of the difference vector such as a Euclidean distance, a Chebyshev distance, an Lp norm of a difference vector, a weighted norm or any other type of difference metric of two vectors can be chosen as the loss function.

In the case of higher-dimensional outputs, such as e.g. two-dimensional, three-dimensional or higher-dimensional outputs, e.g. an elementwise difference metric can be used. Alternatively or additionally, the output data can be transformed before the calculation of a loss value, e.g. into a one-dimensional vector.

In the present case, the machine learning model can be trained to output an item of information on the basis of one or more first image recordings which show at least portions of a target object, wherein the information indicates which target object it is. The machine learning model can be configured as a classification model which assigns one of multiple classes to one or more first image recordings as input data, wherein each class represents a defined target object.

The machine learning model can be trained, for example, to distinguish weeds from cultivated plants. In such a case, the classification model can be configured to assign one or more first image recordings to one of two classes, wherein a first class represents weeds and the other class represents plants (or other objects) which are not weeds (such as cultivated plants).

The machine learning model can be trained, for example, to recognize specific weeds and/or specific cultivated plants. Each specific plant can be represented by one class.

The machine learning model can also be trained to recognize (specific or nonspecific) harmful organisms, such as (specific or nonspecific) insects and/or arachnids. The term “specific” means that a defined phylum, a defined class, a defined order, a defined family, a defined genus, and/or a defined species of a harmful organism is observed. The term “nonspecific” means that a distinction is only made between harmful organism and non-harmful organism, weed and non-weed, animal pest and animal non-pest, or the like.

The machine learning model can also be trained to distinguish animal harmful organisms from beneficial animals. A beneficial organism is understood to mean an organism for which a harmful organism serves as food source or host, or which is important for a successful harvest for other reasons (for example as a pollinator).

The machine learning model can also be trained to distinguish a cultivated plant infected by a pathogen (e.g. bacterium, virus) and/or a fungus from a healthy, uninfected cultivated plant. The machine learning model can also be trained to recognize specific pathogens and/or fungi.

It is also conceivable that the machine learning model is trained to recognize two objects (a first and a second object) simultaneously or successively, or that multiple machine learning models are present, of which a first model is trained to recognize a first object and a second model is trained to recognize a second object. The first object can be, for example, a (specific) cultivated plant and the second object can be, for example, a (specific) harmful organism for the (specific) cultivated plant.

The machine learning model can be trained on the basis of training data. The training data can comprise a large number of reference image recordings of target objects and an item of information about which target object it is in each case. The term “large number” preferably means more than 100. The term “reference image recording” serves merely to differentiate image recordings used for training a machine learning model from image recordings used during use of the trained machine learning model to recognize a target object in an image recording. The information about which object it is in an image recording in each case can be, for example, an identification number assigned to the target object (target value).

The reference image recordings can be fed to the machine learning model and the machine learning model can be configured to generate an output which is to identify the target object, such as an identification number. The output can be compared to the target value. The deviation between the output and the target value can be quantified by means of a loss function. Parameters of the machine learning model can be changed to reduce the deviation to a (defined) minimum. This can be carried out, for example, by means of a back propagation method.

If the deviation between the output and the target value has been reduced to a (defined) minimum for a large number of reference image recordings, the machine learning model thus trained can be used to recognize target objects in unknown image recordings. In this case, the term “unknown” means that a corresponding image recording was not used during the training of the model.

The machine learning model is preferably an artificial neural network or the model comprises such a network.

An artificial neural network comprises at least three layers of processing elements: a first layer with input neurons (nodes), an N-th layer with at least one output neuron (nodes), and N-2 inner layers, where N is a natural number and greater than 2.

The input neurons are used to receive one or more image recordings. The output neurons are used to output output data which identify a target object shown in an image recording.

The processing elements of the layers between the input neurons and the output neurons are connected to one another in a predetermined pattern with predetermined connection weights.

The training of the neural network can, for example, be carried out by means of a back propagation method. In this case, the most reliable possible mapping of given input data onto given output data is sought for the network. The quality of the mapping is described by a loss function. The goal is to minimize the loss function. In the case of the back propagation method, an artificial neural network is taught by the change of the connection weights.

In the trained state, the connection weights between the processing elements contain information regarding the relationship between image recordings and transformed image recordings.

A cross-validation method can be used in order to divide the data into training data sets and validation data sets. The training data set is used in the back propagation training of network weights. The validation data set is used in order to check the accuracy of prediction with which the trained network can be applied to unknown data.

Machine learning models for recognizing harmful organisms are described in the prior art (see for example: WO2021090294A1, DE102018222428A1, US20200045953A1, WO2019/046203A1, EP3804488A1, US20210383535, U.S. Pat. No. 10,599,959).

### Ascertaining a Target Region

If a target object is identified, in a further step, a target region is ascertained to which one or more plant protection agents are to be applied. The target region can be the target object or a part thereof. In the case of an animal harmful organism, the target region is preferably the target object itself/as a whole or a body part such as the head. A target region can also be target objects which represent specific reproductive stages of an animal harmful organism, such as larvae or eggs. In the case of phytopathogenic fungi, the target region is the area of the useful plant infected by the fungus.

In the case of a weed plant, the target region is preferably a part of the target object which has a particularly high sensitivity to plant protection agents and has a high level of importance for the growth or reproduction of the target object. Examples are stem axes, roots, leaf axes, tap axes, taproots, leaf roots, cotyledons, buds, flowers, or parts of flowers.

If the target object is a harmful organism, the region selected as the target region is preferably that in which a plant protection agent produces an effect (preferably an optimum effect). If the target object is, for example, a weed plant and the plant protection agent to be applied (for example a herbicide) is absorbed by the weed plant via the leaves and then results in damage to the weed plant, a leaf is selected as the target region. Furthermore, one side of a leaf can be selected as the target region, for example a leaf upper side (the side of a leaf facing toward the sun) and/or a leaf lower side (the side of a leaf facing away from the sun).

It is also conceivable that multiple target regions are selected, for example in the case of a weed plant multiple leaves and/or multiple areas on a leaf/on multiple leaves.

Using the application technology described in this description, droplets of a liquid plant protection agent having a volume of less than 15 nL can be produced. A spherical droplet having such a size has a diameter of approximately 0.3 mm. If such a droplet is applied to a target object, it wets an area on the target object in a size of approximately 0.07 mm².

It is thus conceivable that a target region is selected which can be significantly smaller than 1 mm². It is furthermore conceivable to wet a larger area than the wetting area of an individual droplet, in that a large number of individual droplets are placed in the target region in the form of a grid adjacent to one another (for example in the form of a square or hexagonal point grid).

The step “ascertaining a target region” can have multiple meanings and/or can comprise multiple substeps depending on the embodiment. If the target region is identical to the target object, the target object can be selected as the target region.

If the target region is a part of the target object, the step “ascertaining a target region” can comprise the substep “identifying a target region”. The target region is preferably identified on the basis of one or more image recordings of the target object.

One or more image recordings which are used to identify a target region are referred to in this description as a second image recording/second image recordings. It is conceivable that one or more second image recordings is/are identical to one or more first image recordings. In other words: it is conceivable that that/those image recording(s) used to identify the target object is/are also used to identify the target region; however, it is also conceivable that different and/or further image recordings are produced, on the basis of which one or more target regions are identified.

In a first step, a weed plant (the target object) can thus be identified on the basis of one first image recording or multiple first image recordings, and in a second step, a leaf or an area of a leaf of the weed plant (the target region) can be identified on the basis of one second image recording or multiple second image recordings. The second image recording(s) can be entirely or partially identical to the first image recording(s) or different therefrom.

One or more second image recordings can be produced (like the first image recording(s)) by at least one image recording unit, such as a camera. Optical elements (such as a camera lens) are preferably used which result in an enlarged image (enlarged in comparison to the original) of the target region on the image. A zoom lens is preferably used.

In one preferred embodiment, multiple image recording units are used which produce second image recordings of the target region from different directions. In one embodiment, the first and the second image recording are each produced from different directions. In one embodiment, the first and the second image recording are each produced from different directions using a first and a second image recording unit. In this way, it is possible to obtain an item of depth information which provides information about distances. Such an item of depth information can be used, for example, to determine a distance of a nozzle of the dosing unit from the target region and/or to perform positioning of the nozzle of the dosing unit in relation to the target region. A stereo camera can be used, for example.

### Applying a Plant Protection Agent to the Target Region

If a target region is ascertained, plant protection agent is applied to the target region.

The application is performed using a dosing unit. It is conceivable that multiple dosing units are used. Such a dosing unit comprises at least one nozzle. Plant protection agent is applied to the target region from the nozzle.

The dosing unit furthermore comprises at least one dispenser for the exact dosing of liquids.

The dosing unit furthermore comprises at least one precision valve which doses the output of the individual droplets through the nozzle. A piezoelectric actuator is preferably used for the dosing.

The dosing unit furthermore comprises an orientation unit, for example an XYZ crossbeam, which can move the dosing unit along three or more axes. The orientation unit can also rotate the dosing unit in a specific spatial direction to change the flight path. The flight path preferably does not extend vertically.

The dosing unit furthermore comprises a storage container for receiving the plant protection agent and a micro-reservoir, which a defined amount of plant protection agent enters from the storage container before this defined amount is applied via the at least one nozzle. Plant protection agent can enter the micro-reservoir from the storage container via a connection. This connection is preferably a pipe or hose.

The step “applying a plant protection agent to the target region” can comprise the step “positioning the dosing unit in relation to the target region”. The application of a plant protection agent can take place perpendicularly (in relation to a surface of the target region) from above and/or from below and/or at an angle other than 90°.

The application preferably takes place at an angle of 45° to 90° in relation to a surface of the target region.

The dosing unit is preferably positioned at a defined distance from the target region with the aid of the orientation unit. The distance is preferably kept constant within defined limits: if a new target region is selected/ascertained, a defined distance is set within the defined limits between the dosing unit or at least one nozzle of the dosing unit and the target region. The distance between at least one nozzle and the target region is preferably at least 10 cm, preferably at least 20 cm. Target points on the target region can preferably thus be hit in a conical area below the dosing unit.

The plant protection agent is preferably applied in the form of one or more individual droplets, the volume of which is in the range from 1 nL to 100 nL, still more preferably in the range from 1 nL to 50 nL, still more preferably in the range from 1 to 30 nL.

It has been possible to show that droplets in the size mentioned can be applied from a distance of 10 cm or more to the target region (such as a leaf upper side or a leaf lower side) of a target object (such as a cultivated plant infected with a fungus or a pathogen or a weed plant), without the droplets bouncing off of the surface of the target region and/or disintegrating into smaller droplets. The applied droplets of the size mentioned reach the surface and remain adhering thereto.

The application of the plant protection agent in the form of individual droplets preferably takes place with the aid of a dosing unit for contactless dosing. Contactless dosing—also referred to as jetting and jet method—is dosing in which a dosed contiguous amount of liquid flies toward the target region freely—thus completely detached from the dosing opening. Contactless dosing permits high-precision portioning of liquid and pasty media and accurate application.

A dosing unit for contactless dosing can have a nozzle in which a movable expulsion element, such as a plunger, can be arranged. To expel plant protection agent, the expulsion element in the interior of the nozzle can be pushed forward in an expulsion direction at high speed in the direction of a nozzle opening, by which an individual droplet of the plant protection agent is expelled from the nozzle. This procedure is referred to in general and hereinafter as an expulsion procedure. The expulsion element can then be retracted again in an opposing retraction direction. The size of the droplets or the amount of the plant protection agent per droplet are predeterminable by the structure and the actuation as well as by the effect of the nozzle thus achieved.

The plant protection agent is preferably “actively” expelled from the nozzle by an (expulsion) movement of the expulsion element relative to the nozzle. During the expulsion procedure, an expulsion tip of the expulsion element preferably comes into contact with the plant protection agent to be dispensed and “presses” or “pushes” the plant protection agent out of the nozzle of the dosing unit due to the (expulsion) movement of the expulsion element and/or the nozzle. The dosing unit according to the present invention therefore differs from other dosing systems, in which a movement of a closure element merely results in opening of the nozzle, wherein a pressurized dosing substance then emerges from the nozzle on its own. This is the case, for example, with injection valves of internal combustion engines.

The expulsion element can preferably moreover be brought into a closure position in which it is firmly connected to a seal seat of the nozzle opening in the nozzle and temporarily remains there. With more viscous plant protection agents, it can also be sufficient for the expulsion element to simply remain in the retracted position, i.e. at a distance from the seal seat, without a droplet of the plant protection agent emerging.

The movement of the expulsion element necessary to expel the plant protection agent can be produced with the aid of an actuator unit of the dosing system. Such an actuator unit can in principle be implemented in various ways, for example, by means of a pneumatically or hydraulically operated actuator. Piezoelectrically and/or electromagnetically operated actuators are preferably used.

Alternatively or additionally to the movable expulsion element, the nozzle of the dosing system itself can be moved in an expulsion or retraction direction to dispense plant protection agent. To dispense the plant protection agent, the nozzle and an expulsion element arranged in the interior of the nozzle can be moved toward one another or away from one another in a relative movement, wherein the relative movement can be carried out either solely by a movement of the nozzle or at least partially also by a corresponding movement of the expulsion element.

After the end of the expulsion movement, the micro-reservoir can be automatically refilled from the storage container.

The individual droplets preferably reach a speed during dosing of 1 m/s to 100 m/s, very preferably 5 m/s to 50 m/s, particularly preferably 5 m/s to 25 m/s.

Dosing systems for contactless dosing of a dosing substance are described in the prior art (see, for example, WO2021/028197A1, WO2020/120176A2, WO2019/197181A1, WO2015/192896A1, WO2014/140195A1); they are typically used for applying soldering agents or adhesives.

As already described, a single droplet of a plant protection agent can be applied or multiple droplets can be applied. In the case of an animal harmful organism, a single droplet can be sufficient to make the harmful organism harmless. In the case of a weed and/or a cultivated plant infected with a pathogen and/or fungus, it can be necessary to apply multiple droplets in order to combat the weed and/or the pathogen and/or the fungus. Multiple droplets can be applied in the form of a defined pattern to the target region, for example in the form of a square or hexagonal point grid. A distribution of droplets along defined features of the target region is also conceivable. Multiple droplets can thus be applied, for example, along the middle vein of a leaf and/or along lateral veins of a leaf.

In one preferred embodiment, the amount of the plant protection agent to be applied is ascertained automatically on the basis of the one or the multiple second image recordings which shows/show the target region. The amount can mean the droplet volume of an individual droplet and/or the number of individual droplets to be applied. The distance of the applied individual droplets from one another in the target region and/or the distribution of the individual droplets in the target region can also be ascertained/established in an automated manner on the basis of the one or the multiple second image recordings.

The high precision and small amount of the applied droplets has the advantage that no plant protection agent reaches other regions, in particular the ground, from the target region and therefore only a minimal surface comes into contact with the plant protection agent.

In one preferred embodiment, the dosing unit can be coupled to an autonomous mobile robot platform, preferably independently of weather. The dosing unit is therefore moved in the direction of travel in addition to the orientation by the orientation unit. Other forms are also possible, however, e.g. add-on device, UAV, or handheld device.

The dosing unit can additionally be installed on a passive or active windscreen in order to prevent a drift of the droplets. The active windscreen influences the airflow in the area of the dispenser with a pneumatic counter pressure. For this purpose, the local wind speed and the gust factor are measured. A model-based prediction algorithm regulates the pneumatic system. This algorithm takes into consideration the gust factor and/or the local windspeed for the ascertainment of the pneumatic counter pressure. The passive windscreen is characterized by a protective unit, such as a protective shield, using which the dosing unit is shielded.

### Documenting the Application

The step “documenting the application” is used to prove that the application is restricted to the target region. In other words, it is established by documenting the application that plant protection agent has been applied exclusively to the target region and no plant protection agent has reached an area outside the target region.

The application is documented on the basis of one third image recording or on the basis of multiple third image recordings.

Such a third image recording shows the target region after the application of one or more individual droplets of the plant protection agent. One individual droplet or multiple individual droplets is/are shown in the target region on such a third image recording.

The production of an image recording of the target region is preferably matched to the expulsion movement of the expulsion element so that before an expulsion movement and a defined time span after an expulsion movement, an image recording of the target region is produced in each case. The defined time span is preferably greater than the time span which an individual droplet requires to reach the target region from the nozzle opening after the expulsion element has expelled the individual droplet. An image recording of the target region can thus be produced before the application of an individual droplet and a further image recording of the target region can be produced after the application of the individual droplet. By comparing the two image recordings (before/after), it is possible to show that an individual droplet has been added in the target region in the image recording which was produced a defined time span after the expulsion movement in comparison to the image recording which was produced before the expulsion movement. The coupling of the expulsion movement with the production of image recordings of the target region thus permits it to be proven that each individual droplet which has been expelled also has actually arrived in the target region.

The one or the multiple third image recordings are produced with the aid of at least one image recording unit; preferably, the same image recording unit is used which was also used for identifying/ascertaining the target region.

It is conceivable that the expulsion movement is also documented, i.e. that it is documented by one or more image recordings that an individual droplet leaves the nozzle opening of the dosing device. A droplet detection unit can be used for this purpose, as is described, for example, in WO2017/060336A1.

The application procedure is preferably recorded in the form of a data set. Such a data set preferably comprises one or more first image recordings of the target object, an item of information about which target object has been identified on the basis of the one or the multiple first image recordings, and one or more third image recordings which show one or more applied individual droplets.

The data set can furthermore comprise one or more second image recordings.

The one or more first image recordings show the target object which is treated using plant protection agent.

The information about which target object has been identified on the basis of the one or the multiple first image recordings can be used to ascertain errors in the identification. The one or the multiple first image recordings of the target object can be viewed by a person who is trained in recognizing the target object in the one or the multiple first image recordings. The person can then check the information about which target object has been identified in the one or the multiple first image recordings by the device according to the invention and establish whether the identification of the device according to the invention was correct or incorrect.

The one or the multiple second image recordings give information about which target region has been selected/ascertained for the application of the plant protection agent.

The one or the multiple third image recordings give information about whether and which amount of plant protection agent has arrived in the target region.

The data set preferably also comprises items of information on the applied amounts, i.e. the amounts which have been dispensed by the dosing unit.

The data set preferably also comprises items of information on the points in time at which droplets have been dispensed by the dosing unit and on the points in time at which image recordings, preferably one or more third image recordings, have been produced.

The data set preferably also comprises items of information on the geo-coordinates of the device according to the invention at the point in time of the identification of the target object and/or at the point in time of the ascertainment/identification of the target region and/or at the point in time of the application of plant protection agent and/or at another point in time and/or at multiple other points in time before, during, and/or after the execution of the method according to the invention. The device according to the invention can be equipped with means for position determination to ascertain the geo-coordinates, for example with a GPS sensor (GPS: Global Positioning System) or another sensor for position determination on the basis of a navigation satellite system.

The data set can be stored in a data memory. It can be output to a person with the aid of a display device (for example a monitor or a printer). It can be transmitted via a transmitting unit to a (separate) computer system. The transmission can take place entirely or partially in a wired manner and/or via radio (for example via mobile radio).

The invention is explained in more detail below with reference to drawings, without wishing to restrict the invention to the features and combinations of features that are shown in the drawings.

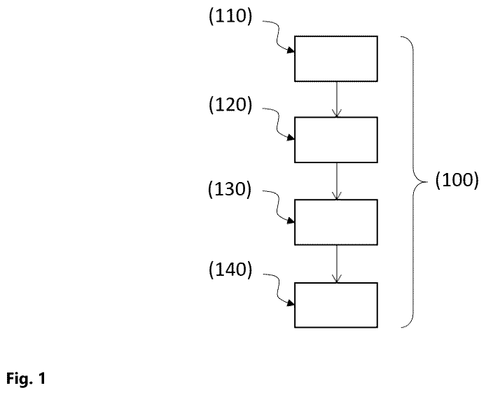

FIG. 1 shows, by way of example and in schematic form, the method according to the invention in the form of four steps in a flow chart.

The method (100) comprises the following steps:
(110) identifying the target object and determining the application amount
(120) ascertaining a target region
(130) applying a plant protection agent to the target region
(140) documenting the application

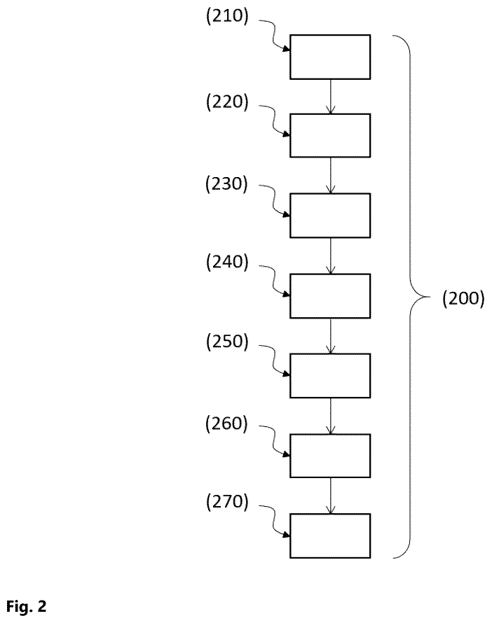

FIG. 2 shows, by way of example and in schematic form, a preferred embodiment of the method according to the invention in the form of a flow chart.

The method (200) comprises the following steps:
(210) producing a first image recording of a target object,
(220) identifying the target object on the basis of the first image recording,
(230) ascertaining a target region on the basis of the first image recording and/or on the basis of a second image recording,
(240) applying an amount of a plant protection agent to the target region with the aid of a dosing unit,
(250) producing a third image recording, wherein the third image recording shows the plant protection agent applied to the target region,
(260) producing a data set comprising
   the first and/or the second image recording,
   an item of information about the ascertained target object, and
   the third image recording,
(270) outputting and/or storing the data set and/or transmitting the data set to a computer system.

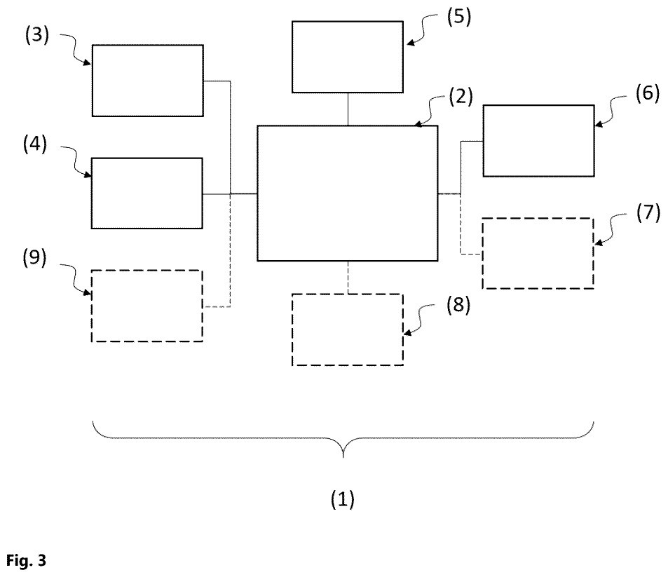

FIG. 3 shows, by way of example and in schematic form, a preferred embodiment of the device according to the invention.

The device (1) comprises
a control and calculation unit (2),
at least one image recording unit (3, 4),
a dosing unit (5), and
a data memory (6).

The device shown in FIG. 3 comprises two image recording units, a first image recording unit (3) and a second image recording unit (4). One first image recording or multiple first image recordings can be produced using the first image recording unit (3), which show at least a portion of a target object, and on the basis of which the target object is identified. One second and/or third image recording or multiple second and/or third image recordings can be produced using the second image recording unit (4). The one or the multiple second image recordings are used to ascertain/identify the target region; the one or the multiple third image recordings are used to prove the exclusive application of plant protection agent to the target region.

The device (1) can optionally comprise a transmitting unit (7) and/or a position determination unit (8) and/or a source (9) for electromagnetic radiation.

The control and calculation unit (2) is configured
to receive a first image recording from the at least one first image recording unit (3),
to identify a target object in the first image recording,
optionally, to receive a second image recording from the at least one second image recording unit (4),
to ascertain a target region on the basis of the first and/or second image recording,
to cause the dosing unit (5) to apply an amount of a plant protection agent to the target region,
to cause the at least one second image recording unit (4) to generate a third image recording, wherein the third image recording shows the plant protection agent applied to the target region,
to generate a data set, wherein the data set comprises
   the first and/or the second image recording,
   an item of information about the ascertained target object, and
   the second image recording, and
to store the data set in the data memory (6) and optionally to cause the transmitting unit (7) to transmit the data set to a computer system.

The position of the device (1) according to the invention can be ascertained using the position determination unit (8).

The target object and/or the target region can be illuminated using the source (9) for electromagnetic radiation, in order to be able to produce image recordings independently of the ambient light (such as sunlight).

The device according to the invention can generally (i.e. not restricted to the embodiment shown in FIG. 3) have means using which the device can move autonomously within a field for cultivated plants. The device according to the invention can be embodied, for example, as a robot or a vehicle. Corresponding means for locomotion are described in the prior art (see, for example: WO2016/116888A1, US20030229425A1, WO2019/100118A1, WO2016/191825, US20200253127A1).

The device according to the invention can generally (i.e. not restricted to the embodiment shown in FIG. 3) have a passive and/or active windscreen. A windscreen can ensure that individual droplets do not drift off of the desired target track on their flight path from the dosing unit in the direction of the target region. A passive windscreen can be achieved, for example, using protective shields. An active windscreen can influence the airflow in the area of the dosing unit, for example using a pneumatic counter pressure. For this purpose, the local wind speed and/or the gust factor can be measured. A model-based prediction algorithm can regulate the pneumatic system.

The present invention unifies accurate application of plant protection agent with proof that plant protection agent has been applied exclusively to defined target regions.

By means of the present invention, plant protection agents can be dosed in ultrasmall amounts so that contamination of groundwater, soil, and/or useful plants is avoided.

By way of the present invention, accompanying plants can be selectively blocked from growing or promoted in growth based on synergy effects. It is therefore possible to maximize the biodiversity in consideration of the overall cost effectiveness in plant cultivation.

Pest populations do not have to be completely removed, but can be reduced to an ecologically reasonable population size.

To increase the quality of the harvest and/or biodiversity, the method according to the invention can be used at regular intervals, preferably daily using preferably one or more autonomous robots and/or vehicles in order to enable continuous plant protection and thus recognize and eliminate problems early.

By way of the present invention, it is also possible in principle to use chemically synthesized plant protection agents in certified organic cultivation by virtue of potentially contaminated plants being transparently identifiable by the documentation of each individual droplet. The digitization in plant cultivation is supposed to break down for end customers at which distance to their product (useful plant) which amount of which substance has been used at which points in time and in which environmental conditions.

1. A method comprising:
(a) producing a first image recording of a target object;
(b) identifying the target object based on the first image recording;
(c) ascertaining a target region based on the first image recording and/or based on a second image recording;
(d) applying an amount of plant protection agent to the target region with the aid of a dosing unit;
(e) producing a third image recording, wherein the third image recording shows the plant protection agent applied to the target region;
(f) generating a data set comprising:
the first and/or the second image recording;
an item of information about the ascertained target object; and
the third image recording;
(g) outputting and/or storing the data set and/or transmitting the data set to a computer system.

2. The method according to claim 1, wherein in step (c) the target region is ascertained based on the first and second image recordings, which are each produced from different directions, and wherein in step (f) the data set additionally comprises the second image recording and an item of depth information with respect to a distance of the dosing unit from the target region, which was obtained from the two image recordings.

3. The method according to claim 1, wherein in step (d) the plant protection agent is applied in the form of one or more individual droplets.

4. The method according to claim 3, wherein in step (e) the third image recording shows one or more individual droplets which have been applied to the target region in step (d).

5. The method according to claim 1, wherein the data set generated in step (f) further comprises a total amount of the plant protection agent applied in the target region.

6. The method according to claim 5, further comprising ascertaining based on the data set generated in step (f) and with reference to the third image recording contained therein whether and which amount of plant protection agent has arrived in the target region.

7. The method according to claim 3, wherein in step (d) the dosing unit has been installed on a windscreen, wherein the method further comprises ensuring that one or more individual droplets of the plant protection agent do not drift off from a desired target track on their flight path from the dosing unit in a direction of the target region.

8. A device comprising:
a control and calculation unit;
at least one image recording unit;
a dosing unit; and
a data memory and/or a transmitting unit;
wherein the control and calculation unit is configured to:
receive a first image recording from the at least one image recording unit;
identify a target object in the first image recording;
receive a second image recording from the at least one image recording unit;
ascertain a target region based on of the first and/or second image recording;
cause the dosing unit to apply an amount of a plant protection agent to the target region;
cause the at least one first image recording unit to generate a third image recording, wherein the third image recording shows the plant protection agent applied to the target region;
generate a data set, wherein the data set comprises:
the first and/or the second image recording;
an item of information about the ascertained target object; and
the second image recording; and
store the data set in the data memory and/or to cause the transmitting unit to transmit the data set to a computer system.

9. The device according to claim 9, wherein the control and calculation unit is configured to:
receive a second image recording from a second image recording unit, wherein the second image recording unit is positioned spatially different relative to the first image recording unit;
ascertain a target region based on the first and second image recordings;
cause the dosing unit to apply an amount of a plant protection agent to the target region;
cause the at least one first image recording unit to generate a third image recording, wherein the third image recording shows the plant protection agent applied to the target region;
generate a data set, wherein the data set comprises:
the first image recording;
an item of information about the ascertained target object; and
the second image recording.

10. The device according to claim 8, wherein the dosing unit contains a storage container, a nozzle, a precision valve, and a micro-reservoir which is capable of applying droplets having a volume from 1 to 100 nL.

11. The device according to claim 10, wherein the droplets have a volume from 1 to 50 nL.

12. The device according to claim 9, wherein the first image recording unit and the second image recording unit are designed in the form of a stereo camera.

13. The device according to claim 8, wherein the dosing unit is installed on a windscreen, wherein the device further comprises ensuring that individual droplets of the plant protection agent do not drift off from a desired target track on their flight path from the dosing unit in a direction of the target region.
